(19) United States
(12) Patent Application Publication
(10) Pub. No.: US 2026/0235210 A1
(43) Pub. Date: Aug. 13, 2026

(54) VALVE UPPER PART FOR SANITARY FITTINGS

(71) Applicant: Flühs Drehtechnik GmbH, Lüdenscheid (DE)

(72) Inventors: Stefan ROICKE, Herscheid (DE); Lutz LANGE, Lüdenscheid (DE)

(73) Assignee: Flühs Drehtechnik GmbH, Lüdenscheid (DE)

(21) Appl. No.: 19/157,448

(22) PCT Filed: Feb. 8, 2024
(86) PCT No.: PCT/EP2024/053245

§ 371 Date: Aug. 18, 2025

(30) Foreign Application Priority Data
Mar. 10, 2023 (EP) 23161223.5

(51) Int. Cl. F16K 1/52; F16K 31/524

(52) U.S. Cl. CPC F16K 1/523; F16K 31/524

(57) ABSTRACT

In a valve upper part with a top piece through which a control spindle passes axially, via which a valve body arranged in the piece is actuatable and which is connected to an operating part having a handle, the handle is fixable to move relative to the piece coaxially to the spindle, in at least two axial positions via an arranged locking device that includes at least one cam slot having at least two locking positions, in which an engaging part engages, the engaging part being arranged on a handle-connected control component movable relative to the slot coaxially to the spindle. The engaging part is formed by a ball introduced into a slotted borehole in the component to engage with a ball section in the control cam. A ball cage encloses the slotted borehole, in which the ball is guided in a rotating and radially movable manner.

The invention relates to an upper valve part having a head piece through which a control spindle passes axially, by way of which spindle a valve body arranged in the head piece can be activated and which spindle is connected to an operating part that comprises a handle, wherein the handle can be displaceably fixed in place in at least two axial positions, relative to the head piece, coaxially to the control spindle, by way of a locking device that is provided, and wherein the locking device comprises a curved track that has at least two locking positions, into which track an engagement part that is provided engages.

The exit of media from fittings is controlled using upper valve parts. For this purpose, the upper valve part is screwed into the housing of a fitting by means of its head piece. Upper valve parts of the aforementioned type are known in the most varied configurations. Thus, for example, an upper valve part is known from EP 1 696 162 A1 , which part has a head piece through which a spindle passes, which spindle is connected to a control disk in the head piece with shape fit, which disk lies against an inlet disk arranged fixed in place. By means of rotating the control disk relative to the inlet disk, it is possible to control the through-flow of water. To activate the spindle, it is structured, on the outside, on its end face that projects out of the head piece, as an outside polygon, and, on the inside, it is provided with a threaded dead-end hole for shape-fit attachment of a turning handle.

Furthermore, from EP 2 522 887 A1 an upper valve part is known in which a valve body is provided to control the through-flow of a fluid, which body can be moved linearly within the head piece by way of a spindle. In this regard, a spindle is mounted in a head piece so as to rotate, and is connected to a valve body that is axially guided in the head piece in a torque-proof manner, by way of a thread. A rotation of the spindle thereby brings about an axial movement of the valve body within the head piece.

In the design of fittings, operation of the upper valve part by way of pushbuttons or buttons is increasingly desired. For this purpose, electromagnetically operated valves are increasingly being used. However, it is a disadvantage of these upper valve parts that the electromagnetic contacts can be affected when the upper valve part is screwed or glued in place, and thereby their reliability is impaired. Furthermore, such valves require an additional voltage source. In addition, amount control is generally not possible in the case of these valves.

To overcome these disadvantages, an upper valve part is proposed in EP 3 366 959 A1 , in which the handle is has a control cap with which it can be displaced along the head piece and by way of which a control piston can be activated, wherein a control motion link that has two locking positions is introduced into the mantle surface of the head piece, on the outside, into which link a guide pin arranged on the control cap engages, which pin is biased against the control motion link by way of a spring. By means of pressure activation of the handle using the control cap, guided axial movement of the control piston is achieved, which cap can be locked in place in at least two positions, for example in the positions “valve open” and “valve closed.” The control cap is biased in the direction opposite to the head piece by way of a spring element.

Locking by way of the guide pins arranged in the control cap, which pins engage into the control motion link, has proven itself in practice. However, it has been shown that the guide pins that engage into the control motion link are exposed to great bending stresses, in particular when the control cap is brought into its starting position by means of the biased spring element. This stress is particularly great if the user allows the handle part that is connected to the control cap to “snap back” after it has been activated. Excessive stress on the guide pins can lead to malfunctions of the locking device.

This is where the invention takes its start. The invention is based on the task of making available an upper valve part of the aforementioned type, in which malfunctions of the locking device is avoided. According to the invention, this task is accomplished by means of a valve device having the characteristics of claim 1.

With the invention, an upper valve part of the above type is made available, in which impairment of the locking device is avoided. Because of the fact that the engagement part is formed by a ball that is introduced into an elongated hole bore arranged in the component, in such a manner that it engages into the control cam with a spherical section, wherein a ball cage is arranged to surround the elongated hole bore, in which cage the ball is guided to rotate and be radially movable, malfunctions that occasionally occur due to guide pins or their guides being deformed due to excessive stress are avoided. Furthermore, since the ball is guided to rotate, rotation of the handle indicated by the ball is avoided when the handle is activated.

In a further development of the invention, an annular spring is arranged in the ball cage, by way of which spring the at least one ball is biased against the control cam. In this way, the ball is reliably guided in the control cam. Furthermore, the annular spring also allows radial movement of the ball within the ball cage, and thereby radial stresses of the ball can be attenuated.

In an embodiment of the invention, the ball cage is configured in ring shape and has an inner circumferential groove in which the ball is guided. In this way, the same radial freedom of movement exists in every circumferential position of the ball. The annular spring is positioned in the groove between ball and ball cage, and, in every circumferential position of the ball, guarantees uniform radial attenuation of possible radial stresses.

In a further embodiment of the invention, the control component is formed by a control cylinder into which at least one elongated hole bore is introduced, and in which a control piston is displaceably arranged, which piston has the control cam. In this way, a compact method of construction is achieved. It is advantageous if the ball cage comprises a delimitation sleeve that surrounds the control cylinder and is attached to the cylinder surrounding the at least one elongated hole bore. By means of the delimitation sleeve, exit of the balls from the control motion link is prevented.

In a further development of the invention, a spring is arranged between the control cylinder and the control piston, which spring is biased against the control cylinder. In this way, automatic return of the control cylinder connected to the handle, along the control piston, is brought about after an activation force has been in effect.

In an embodiment of the invention, a holder for connecting to a connection section of the control spindle is arranged on the control piston, by way of which holder the control piston is connected to the control spindle. It is advantageous if the holder is configured for a shape-fit connection to a connection section of a control spindle, which section is correspondingly configured to be non-round. As a result, transfer of a torque from the handle to the control piston and to a control spindle of an upper valve part connected to the piston is made possible. By pressing on the handle, it can be moved out of a moved-in position into an operating position by way of the locking device, and afterward activation of an upper valve part connected to the handle is made possible by turning the handle.

In an embodiment of the invention, the handle has a setting sleeve that surrounds the control piston, at least in certain regions. In this way, the handle is guided along the control piston, wherein the locking device acts between the control piston and the control cylinder that is arranged in the setting sleeve. Preferably, the control piston has a non-round outside cross-section, and the control cylinder has an inside cross-section that corresponds to this outside cross-section, and thereby the control piston is guided in the control cylinder in a torque-proof but displaceable manner.

In a further development of the invention, the setting sleeve has an inner gear mechanism that engages into an outer gear mechanism arranged on the control piston, and thereby the handle is guided to be axially displaceable along the control piston. In this way, a torque-proof connection of the setting sleeve to the control piston is achieved, with simultaneous axial displaceability. Preferably, a drive piece is provided, which has the outer gear mechanism and which is connected to the control piston in a torque-proof manner.

In an embodiment of the invention, the control cylinder has an outside thread onto which an adapter piece is screwed with its inside thread, wherein the adapter piece is held in the setting sleeve of the handle in a torque-proof as well as longitudinally displaceable manner. In this way, precise adjustment of the axial position of the handle on the spindle of an upper valve part installed in a wall is made possible. By means of longitudinal displacement of the handle into an adjustment position in which the setting sleeve does not engage into the outer gear mechanism of the control piston with its inner gear mechanism, a longitudinal adjustment of the adapter piece takes place along the outside thread of the control cylinder by means of rotation of the handle. Imprecisions during the course of installation of an upper valve part and during cutting to length of the control spindle, as needed, which usually takes place during this process, can thereby be balanced out by means of adjustment of the adapter piece.

In a further embodiment, the adapter piece has engagement projections, wherein at least one engagement groove is provided on the inside, in the setting sleeve, into which groove the engagement projections can be locked in a defined position of the adapter piece. In this way, defined axial positioning of the adapter piece in the setting sleeve is made possible, in which no engagement of its inner gear mechanism into the outer gear mechanism of o the control piston exists (adjustment position).

Preferably, at least two engagement grooves that preferably run radially are provided on the inside, in the setting sleeve, axially spaced apart from one another. In this way, a first axial positioning of the adapter piece is made possible for adjustment, and a second defined positioning of the adapter piece into the operating position, with engagement of its inner gear mechanism into the outer gear mechanism of the control piston, is made possible.

In a further embodiment of the invention, an installation sleeve is provided, the inside diameter of which essentially corresponds to the outside diameter of the handle, wherein the position of the handle can be adjusted at a defined distance from the installation sleeve. Preferably, the installation sleeve has a circumferential collar that forms a common plane with the surface of the handle during positioning of the handle in a defined position in the installation sleeve. In this way, optically attractive integration of the handle into a plane that surrounds it is made possible. The collar can be configured both in ring shape and in the form of a plate having any geometrical shape.

Furthermore, an object of the present invention is a sanitary fitting having an upper valve part for sanitary fittings, in accordance with claim 14.

In the present case, the adjustment position is understood to be the position of the handle in which the engagement projections of the adapter piece engages into the second, lower engagement groove of the setting sleeve. In this position, adjustment by way of the threaded engagement between the outside thread of the control cylinder and the inside thread of the adapter piece is made possible. The inner gear mechanism of the setting sleeve is out of engagement with the outer gear mechanism of the control piston.

In the present case, the operating position is understood to be the position of the handle in which the engagement projections of the adapter piece engages into the first, upper engagement groove of the setting sleeve. In this position, the inner gear mechanism of the setting sleeve is in engagement with the outer gear mechanism of the control piston. Adjustment by way of the threaded engagement between the outside thread of the control cylinder and the inside thread of the adapter piece is not possible.

In the present case, the operating position is understood to be the position of the handle in which the balls make contact in the upper position of the control motion link. The handle is thereby “moved out” for simple operation.

In the present case, the moved-in position is understood to be the position of the handle in which the balls make contact in the holding region of the control motion link. Here, the handle is locked in place in a moved-in position, in which the handle lies flush with an area surrounding this handle, for example.

Other further developments and embodiments of the invention are indicated in the other dependent claims. Exemplary embodiments are shown in the drawings and will be described in detail below. The figures show:

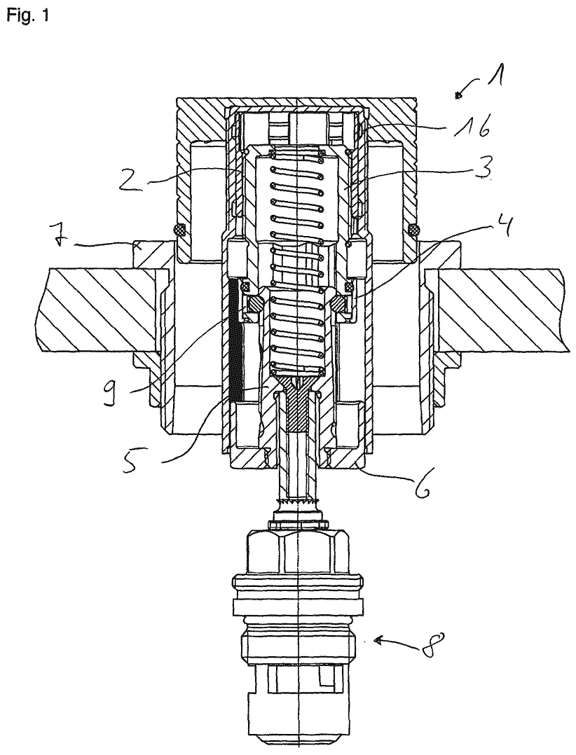

FIG. 1: the schematic representation of an upper valve part with an operating device after rough assembly, with the handle in the operating position;

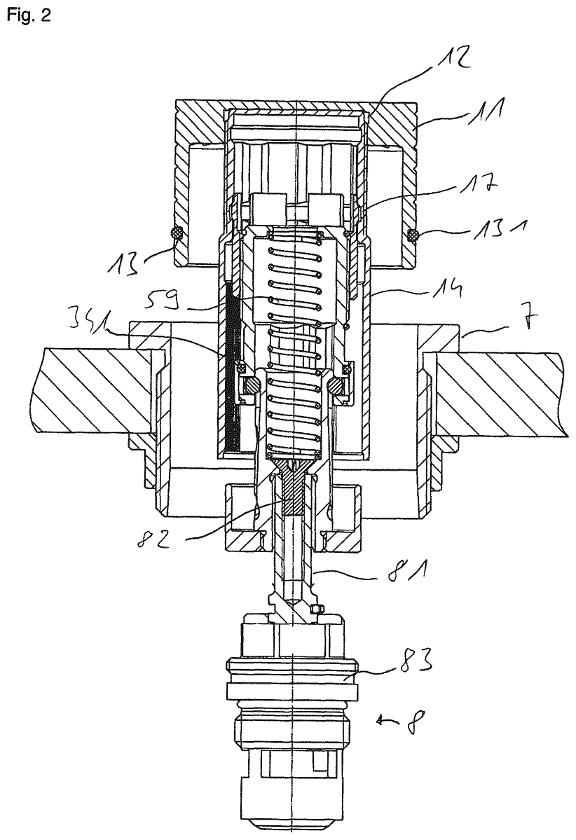

FIG. 2: the schematic representation of the upper valve part with the operating device according to FIG. 1, with the handle in the adjustment position (before adjustment has taken place);

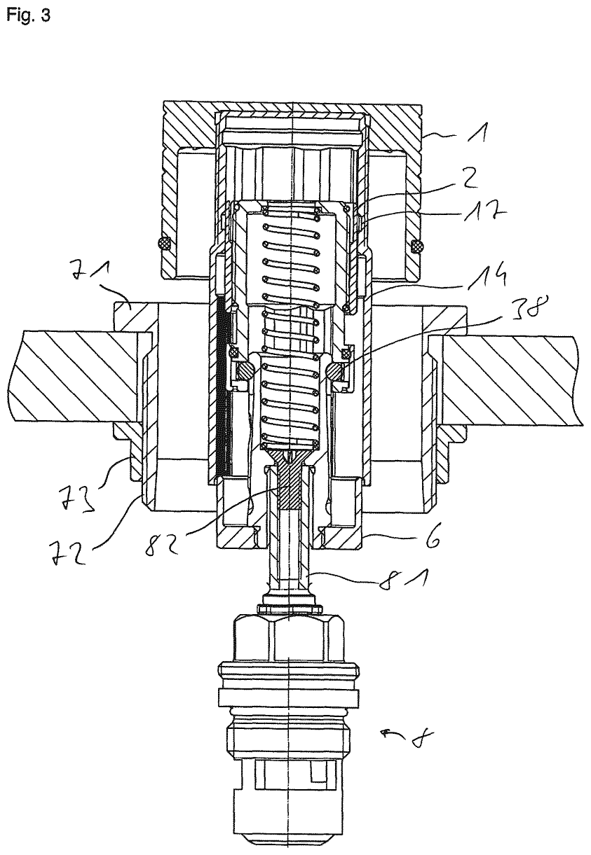

FIG. 3: the schematic representation of the upper valve part with the operating device according to FIG. 2 after adjustment of the handle has taken place;

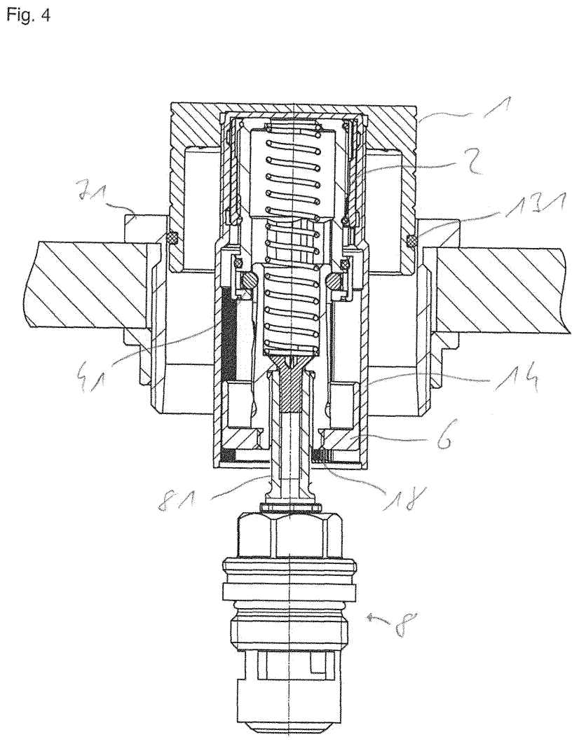

FIG. 4: the schematic representation of the upper valve part with the operating device according to FIG. 3, with the handle in the operating position;

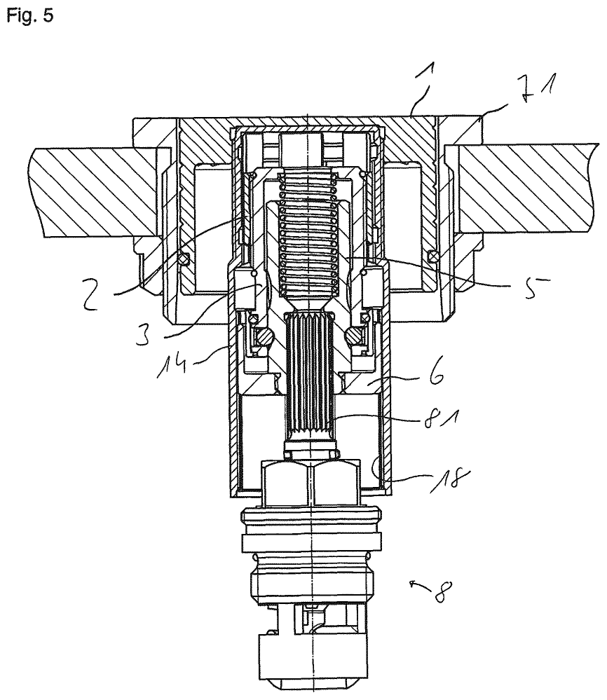

FIG. 5: the representation of the upper valve part with the operating device from FIG. 4, with the handle in the moved-in position;

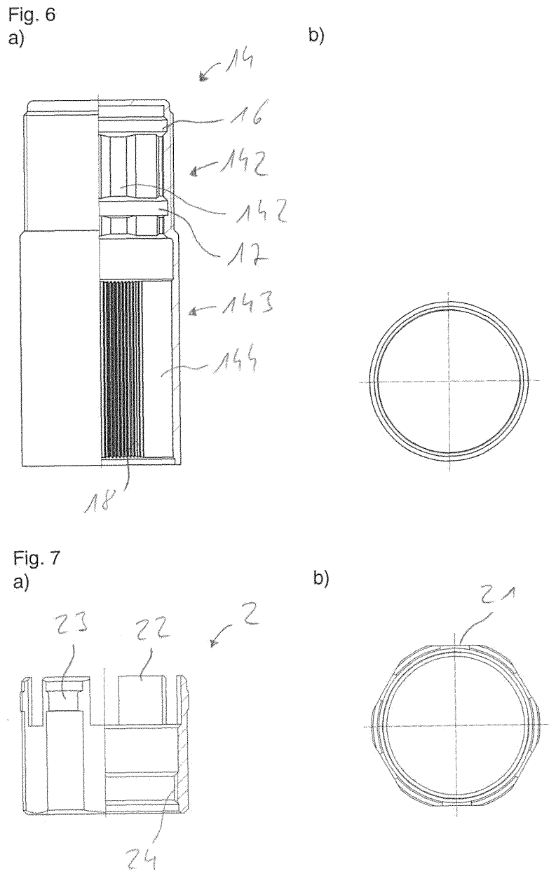

FIG. 6: the schematic representation of the setting sleeve of the handle of the operating device from FIG. 1
a) in partial section;
b) in a top view;

FIG. 7: the schematic representation of the adapter piece of the operating device from FIG. 1
a) in partial section;
b) in a top view;

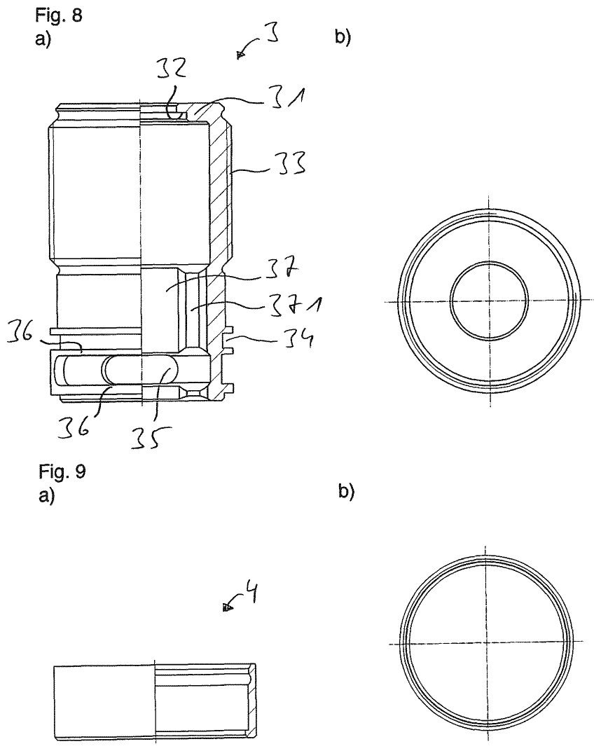

FIG. 8: the schematic representation of the control cylinder of the operating device from FIG. 1
a) in partial section;
b) in a top view;

FIG. 9: the schematic representation of the delimitation sleeve of the control cylinder of the operating device from FIG. 1
a) in partial section;
b) in a top view;

FIG. 10: the schematic representation of the control piston of the operating device from FIG. 1
a) in a side view;
b) in longitudinal section;
c) in a top view;

FIG. 11: the schematic representation of the drive piece of the control piston of the operating device from FIG. 1
a) in partial section;
a) in a top view;

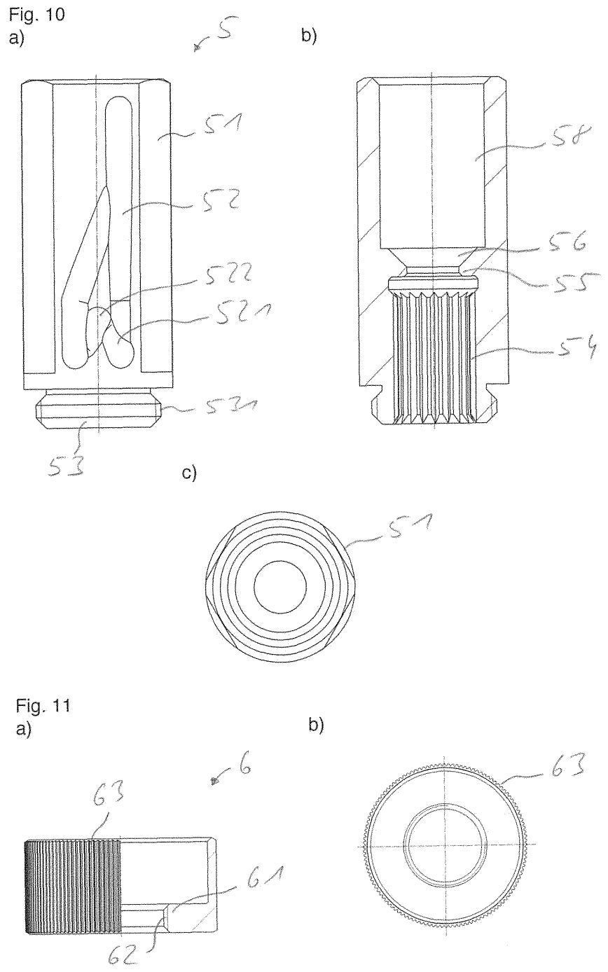

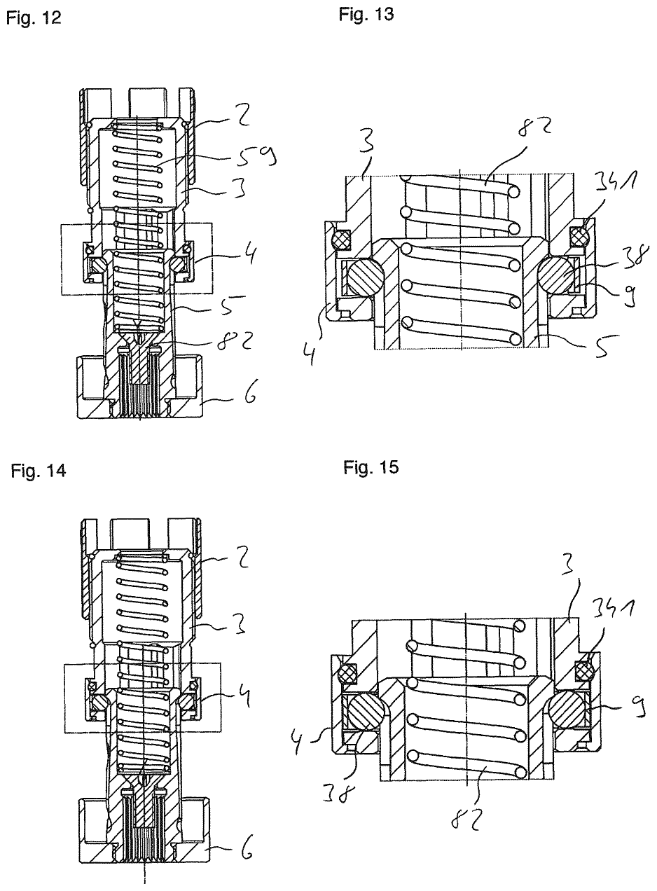

FIG. 12: the schematic representation of the operating device (without the handle) from FIG. 3 in the operating position;

FIG. 13: the detail representation of the ball cage of the operating device from FIG. 12;

FIG. 14: the representation of the operating device from FIG. 12 with an increased tension load at the control cylinder;

FIG. 15: the detail representation of the ball cage of the operating device from FIG. 14;

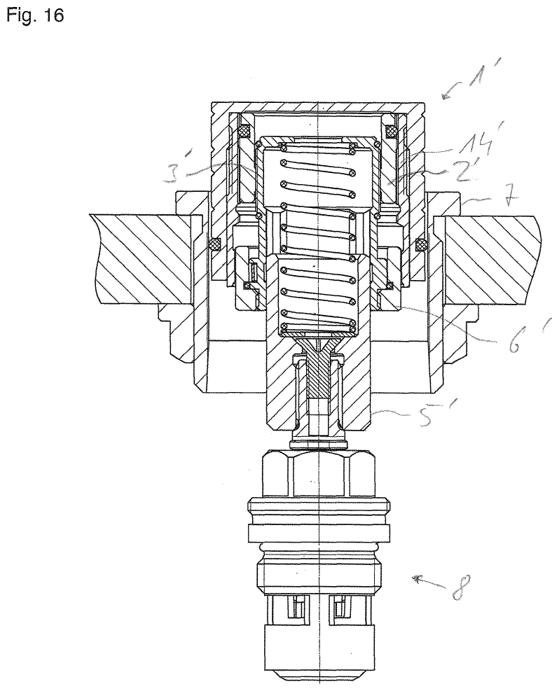

FIG. 16: the schematic representation of an upper valve part with the operating device in a further embodiment, with the handle in the operating position;

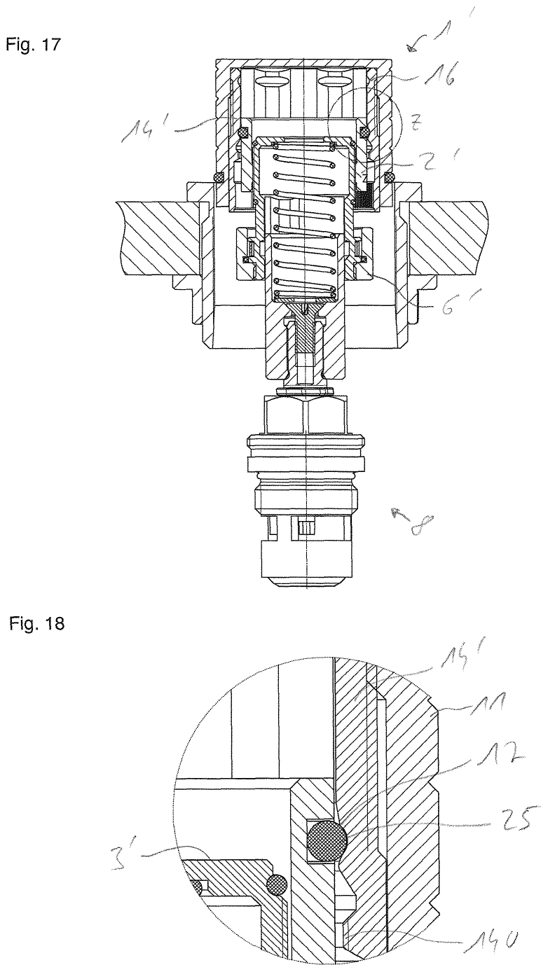

FIG. 17: the schematic representation of the upper valve part with the operating device according to FIG. 16, with the handle in the adjustment position;

FIG. 18: the detail representation of the Detail Z from FIG. 17;

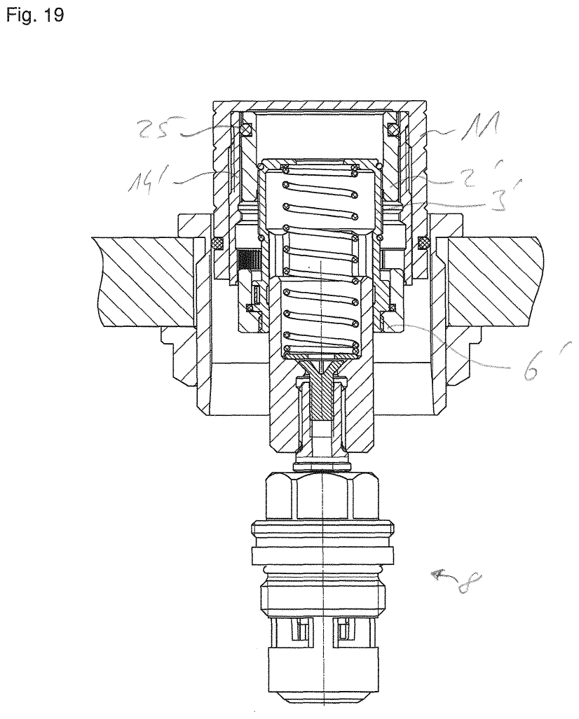

FIG. 19: the schematic representation of the upper valve part with the operating device according to FIG. 16, with the handle adjustment in the maximum height setting;

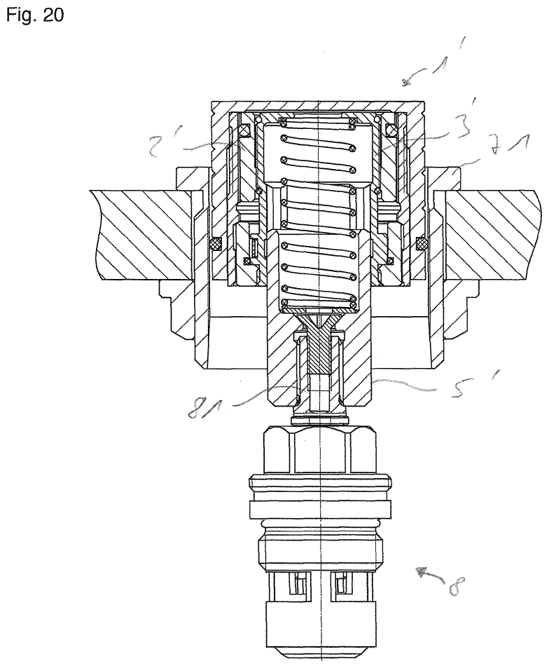

FIG. 20: the schematic representation of the upper valve part with the operating device according to FIG. 16, with the handle adjustment in the minimum height setting;

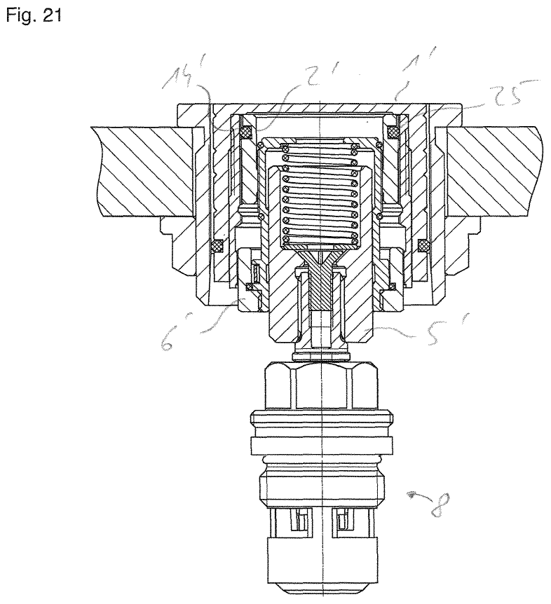

FIG. 21: the schematic representation of the upper valve part with the operating device according to FIG. 16, with the handle in the pressed position;

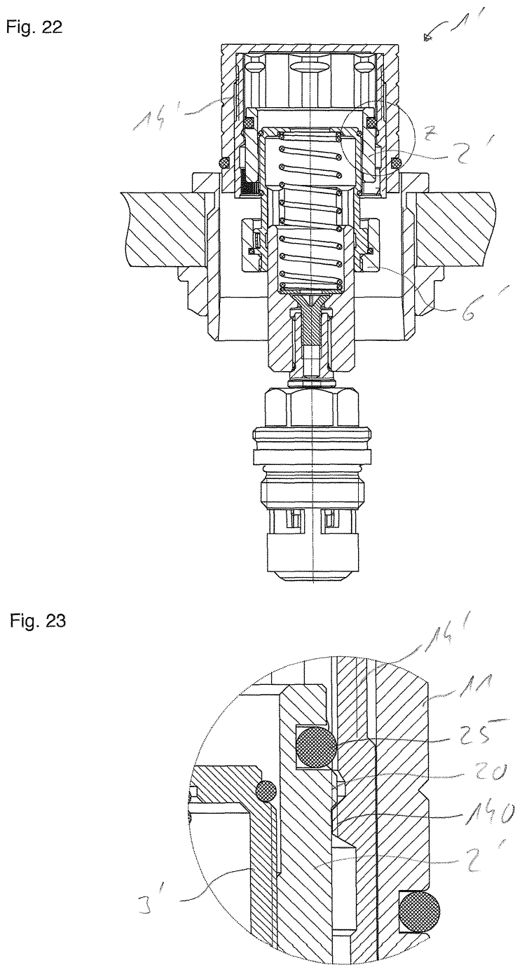

FIG. 22: the schematic representation of the upper valve part with the operating device according to FIG. 16, with the handle in the trigger safety position;

FIG. 23: the detail representation of the Detail Z from FIG. 22;

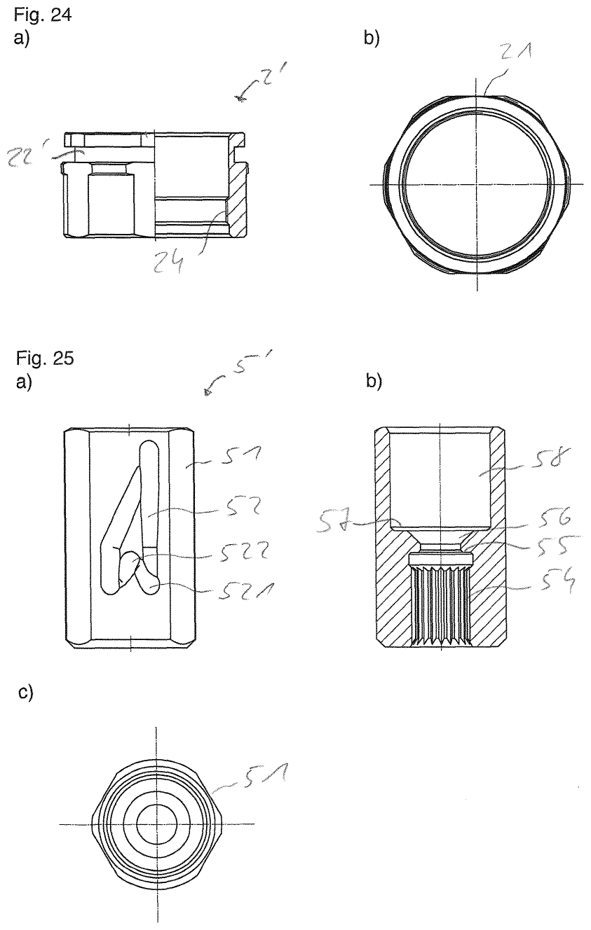

FIG. 24: the schematic representation of the adapter piece of the operating device from FIG. 16
a) in partial section;
b) in a top view;

FIG. 25: the schematic representation of the control piston of the operating device from FIG. 16
a) in a side view;
b) in longitudinal section;
c) in a top view;

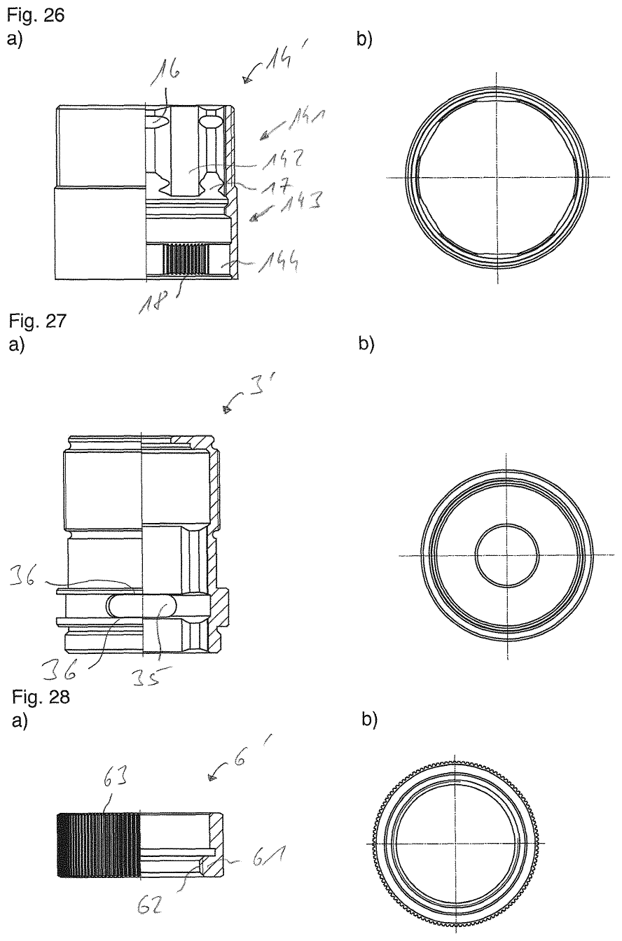

FIG. 26: the schematic representation of the setting sleeve of the handle of the operating device from FIG. 16
a) in partial section;
b) in a top view;

FIG. 27: the schematic representation of the control cylinder of the operating device from FIG. 16
a) in partial section;
b) in a top view;

FIG. 28: the schematic representation of the drive piece of the control piston of the operating device from FIG. 16
a) in partial section;
b) in a top view.

The operating device selected as an exemplary embodiment according to FIG. 1 essentially comprises a handle 1, in which an adapter piece 2 is arranged to be axially displaceable, which piece holds a control cylinder 3 with which it is in threaded engagement, which cylinder is provided with a delimitation sleeve 4 on the end side, and in which cylinder a control piston 5 is arranged to be axially displaceable, which piston is provided with a drive piece 6 on the end side and has a holder for a shape-fit connection to the connection section 82 of the control spindle 81 of an upper valve part 8, which section is non-round in this example. Alternatively, the connection section of the control spindle 81 can also be configured cylindrically. In this case, a torque-proof connection by means of gluing, for example, is required.

The handle 1 is formed by a handle piece 11 that is configured to be hollow-cylindrical and pot-shaped, which piece has a threaded bore 12 centrally on the inside, into which bore a setting sleeve 14 is screwed and glued in place coaxially to the cylindrical side wall of the handle piece 11. Alternatively, the handle 1 can also be configured in one piece. On the outside, the handle piece 11 is provided with a sealing groove 13 that holds an O-ring 131. The handle piece 11 and setting sleeve 14 are produced as turned brass parts in the exemplary embodiment.

The setting sleeve 14 is configured essentially as a hollow cylinder and has a first section 141 that is followed by a second section 143 having a widened diameter. The first section 141 is provided with an outside thread 145 on the outside, with which the setting sleeve in 14 is screwed into the threaded bore 12 of the handle piece 11 and glued in place. In the first section 141, in its inner mantle surface, which has an extensively dodecagonal cross-section, a first upper engagement groove 16 and, at a distance from it, a second lower engagement groove 17 are provided. The extensively dodecagonal cross-section contour of the inner mantle surface of the first section 141 serves for holding the adapter piece 2 in a torque-proof manner, the outer mantle surface of which piece has a corresponding dodecagonal cross-sectional contour. The extensively dodecagonal cross-sectional contour of the inner mantle surface of the first section 141, as well as of the outer mantle surface of the adapter piece 2, is achieved by means of six rectangular flattened areas 142, 21 that are introduced into the cylinder mantle surface at regular intervals.

Alternatively, in place of the dodecagonal cross-sectional contour, any other non-round, preferably polygonal contour can also be used. The second section 143 is provided with an inner gear mechanism 18 that extends, to a great extent, over the entire inner mantle surface of the second section 143. The inner mantle surface of the second section 143 has an extensively octagonal cross-sectional contour, which is achieved by means of four rectangular flattened areas 144 that are introduced into the inner cylinder mantle surface that is provided with the inner gear mechanism 18, spaced at regular intervals.

The adapter piece 2 is configured essentially as a hollow cylinder and, as has already been explained, has an outer mantle surface that corresponds to the inner mantle surface of the setting sleeve 14, with an almost dodecagonal cross-section. In the region of every flattened area 21, a rectangular recess is introduced into the adapter piece 2, in each instance, on its side that faces the threaded bore 12 of the handle piece 11, and thereby six engagement tongues 22 are delimited, arranged circumferentially, at regular intervals from one another, which tongues have engagement projections 23 that run radially and project outward, for engagement into the engagement grooves 16, 17 of the setting sleeve 14. On its inner mantle surface, the adapter piece 2 is provided with an inside thread 24. In the exemplary embodiment, the adapter piece 2 is produced from plastic.

The control cylinder 3 is configured essentially as a turned brass part in the form of a hollow cylinder. On its end face that faces the adapter piece 2, the control cylinder 3 has a ledge 31 that reduces the inside diameter, into which ledge a step 32 is introduced on the inside. On the outside, the control cylinder 3 has an outside thread 33 that extends approximately over half its length. At a distance from the outside thread 33, a groove 34 for holding an O-ring 341 is provided. The groove 34 is followed by two diametrically opposite elongated hole bores 35 that extend radially, surrounded by two circumferential ridges 36 that are spaced axially apart. Between the elongated hole bores 35 and the outside thread 33, the control cylinder 3 has a ledge 37 that narrows the diameter, on the inside, into which ledge four guide notches 371 are introduced circumferentially, radially at a distance from one another. The guide notches 371 serve for torque-proof guidance of the control piston 5.

A ball 38 is introduced into the two elongated hole bores 35, in each instance, which ball is slightly smaller in diameter than the width of the elongated hole bore 35, so that the ball projects, in certain regions, through the corresponding elongated hole bore 35, and is guided between the ridges 36 so as to move radially and rotationally. On its end-side section that has the elongated hole bores 35, a delimitation sleeve 4 is present on the control cylinder 3, in which sleeve an annular spring 9 is arranged. The delimitation sleeve 4 encloses the ridges 36 and is held in place by an O-ring 341. The delimitation sleeve 4 forms a ball cage for the two balls 38, together with the ridges 36, the annular spring 9, and the elongated hole bores 35, by means of which cage their movement in the radial direction is limited.

The control piston 5 is configured as an essentially cylindrical turned brass part. Four flattened areas 51 are introduced into its cylindrical outer mantle surface, radially at a distance from one another, and thereby an essentially octagonal cross-section is formed. By way of the corners formed in this manner, the control piston 5 is guided in the guide notches 371 of the control cylinder 3. Furthermore, two control motion links 52 are introduced between two flattened areas 51, in each instance, into the outer mantle surface, diametrically opposite one another. On its end facing away from the control cylinder 3, a diameter-reducing ledge 53 is provided, which has an outside thread 531. A holder 54 configured in the form of an inside polygon extends through the ledge 53, for the control spindle 81 of an upper valve part 8, which spindle has an outside polygon. The holder 54 is followed by a section 55 having a reduced inside diameter, into which section a conical bore 56 is centrally introduced to hold the head of a countersunk screw 82. The section 55 having a reduced inside diameter is followed by a section 58 having a widened inside diameter, by means of which a ledge 57 is formed, which serves as a spring seat for a pressure spring 59.

The drive piece 6 is configured as a turned brass part essentially in the form of a hollow cylinder, and has a section 61 having a reduced inside diameter at its end that lies opposite the control cylinder 3, which section is provided with an inside thread 62. The outer mantle surface of the drive piece 6 is provided with an outer gear mechanism 63 for engagement into the inner gear mechanism 18 of the setting sleeve 14.

The adapter piece 2 is screwed onto the outside thread 33 of the control cylinder 3 with its inside thread 24. The control piston 5 is inserted into the control cylinder 3 and is guided in the control cylinder 3 in a torque-proof but axially displaceable manner, by means of its non-round outer mantle surface that is configured to correspond to the inner mantle surface of the control cylinder 3. In this regard, the balls 38 that pass through the elongated hole bores 35 of the control cylinder 3 in certain regions engage into a control motion link 52 of the control piston 5, in each instance. The pressure spring 59 lies against the ledge 57 of the control piston 5 and is biased against the setting sleeve on its opposite side.

In the operating position of the handle 1 with its setting sleeve 14, into which the engagement projections 23 of the engagement tongues 22 of the adapter piece 2 screwed onto the handle engage into the upper, first engagement groove 16 of the setting sleeve 14, the inner gear mechanism of the setting sleeve 14 is in engagement with the outer gear mechanism 63 of the drive piece 6. In this operating position, transfer of a torque from the handle 1 to the drive piece 6 that is connected to the control spindle 81 of the upper valve part 8 is made possible. The upper valve part 8 is configured in accordance with EP 1 696 162 A1 in the exemplary embodiment. It has a head piece 83 through which the control spindle 81 passes axially.

During the wall-side installation of a sanitary fitting, for example a shower fitting, the water lines are connected to an upper valve part 8 of the fitting by the installer, in the wall. The upper valve part 8 regularly has a long control spindle 81 that is cut to a desired length after completion of all the wall-side work, including possible tile work. Surrounding the control spindle 81, the wall passage is provided with an installation sleeve 7. The control spindle 81 is introduced, with its outer gear mechanism, into the holder 54 of the control piston 5, which holder has an inner gear mechanism and is fastened in place by way of a countersunk screw 82. Such an installation situation is shown schematically in FIG. 1. Because of imprecisions in the installation of the upper valve part 8 and cutting to length of the control spindle 81, the handle piece 11 of the handle 1 clearly projects beyond the collar 71 of the installation sleeve 7, which has an outside thread 72 in this exemplary embodiment, which thread is screwed together with a counter-nut 73.

The handle 1 can now be displaced on the adapter piece 2 with its setting sleeve 14, which is longitudinally displaceably connected to the adapter piece 2, by pulling on the handle piece 11 until the engagement projections 23 of the engagement tongues 22 engage into the second, lower engagement groove 17 of the setting sleeve 14. In this position, the inner gear mechanism 18 of the setting sleeve 14 is out of engagement with the outer gear mechanism 63 of the drive piece 6 (see FIG. 2). By means of rotating the handle piece 11, the adapter piece 2, which is connected to the setting sleeve 14 in a torque-proof manner, can now be adjusted axially relative to the control cylinder 3, by way of the threaded engagement with the outside thread 33 of the cylinder (see FIG. 3).

When switching the handle 1, with its setting sleeve 14, from the operating position into the adjustment position, a tension force is necessary to bring the engagement projections 23 of the engagement tongues 22 out of the first, upper engagement groove 16, so as to bring the engagement projections 23 into the second, lower engagement groove 17. By means of this tension force, a tension force is simultaneously produced between the control cylinder 3 and the control piston, and thereby the balls 38 that are guided on in the control motion link 52 of the control piston 5 are pressed radially outward against the annular spring 9. Exit of the balls 38 from the control motion link 52 is prevented by means of the delimitation sleeve 4 (see FIGS. 13 and 15).

Subsequently, the setting sleeve 14 can be displaced again along the adapter piece 2, by means of pressure on the handle piece 11, until the engagement projections 23 of the engagement tongues 22 engage into the first, upper engagement groove 16 of the setting sleeve 14. The operating unit is now adjusted relative to the installation sleeve 7. It is in the operating position (see FIG. 4).

By means of pressing on the handle 1, the control cylinder 3 is moved along the control piston 5 by way of the setting sleeve 14, wherein the balls 38 run in the control motion link 52. In this regard, the balls 38 can move radially in the elongated hole bores 35. When the control piston 5 makes contact in the control cylinder 3, the balls 38 reach the switch-over section 521 of the corresponding control cam 52. After the handle 1 is let go, the control cylinder 3 is moved back by means of the reset force of the pressure spring 59, and thereby the balls 38 are moved into the holding region 522 of the control motion link 52. In this position, the handle 1 is held in place by the balls 38. In this position, the handle 1 is countersunk completely into the installation sleeve 7 in the moved-in position, wherein the surfaces of the handle 1 and the collar 71 of the installation sleeve 7 lie in one plane.

When the handle 1 is pressed again, the balls 38 are moved out of the holding region 522 of the control motion link 52. After the handle 1 is let go, the control cylinder 3 is now moved completely back by means of the reset force of the pressure spring 59. In this operating position, the handle projects far out of the installation sleeve 7. By means of the engagement of the inner gear mechanism 18 of the setting sleeve 14 with the outer gear mechanism 63 of the drive piece 6, which piece is connected to the control spindle 81 of the upper valve part 8 by way of the control piston 5, activation of the upper valve part 8 can now take place by means of rotation of the control spindle 81 by way of the handle 1. After activation of the upper valve part 8 has taken place, the handle 1 can be countersunk into the installation sleeve 7 again by pressing on the handle once again.

The operating device selected as an exemplary embodiment according to FIG. 16 is configured to be very compact. It once again comprises a handle 1′, in which an adapter piece 2′ is arranged to be axially displaceable, which piece holds a control cylinder 3′ with which it is in threaded engagement, in which cylinder a control piston 5′ is arranged to be axially displaceable, and which cylinder has a holder for a shape-fit connection to the non-round connection section 82 of the control spindle 81 of an upper valve part 8. In this exemplary embodiment, the drive piece 6′ is arranged at the end of the control cylinder 3′ and simultaneously takes on the function of the delimitation sleeve 4, for which reason a separate delimitation sleeve is not present here. In FIGS. 16 to 28, parts of this further exemplary embodiment that correspond to the first exemplary embodiment are provided with the same reference numbers.

The handle 1′ is provided with an inside thread 12 into which a setting sleeve 14′ is screwed and glued in place. The setting sleeve 14′ once again has a first section 141 that is followed by a second section 143. While the first section 141 essentially corresponds to the first section of the setting sleeve 14 of the first exemplary embodiment, the second section 143 is configured to be significantly shorter. The second section 143 is once again provided with an inner gear mechanism 18, which extends over its inner mantle surface to a great extent, wherein the inner mantle surface of the second section 143 has an extensively octagonal cross-section contour, which is achieved by means of four rectangular flattened areas 144 introduced into the inner cylinder mantle surface provided with the inner gear mechanism 18, at regular intervals.

In this exemplary embodiment, the adapter piece 2′ is also configured to be shorter. In place of the engagement tongues that are arranged at regular intervals from one another, here a circumferential groove 22′ is provided, which holds an O-ring 25 for engagement into the engagement grooves 16, 17 of the setting sleeve 14.

The control cylinder 3′ is also configured to be shorter, and this is particularly brought about by means of the shorter upper part provided with the outside thread. Once again, a ball 38 is introduced, in each instance, into the two elongated hole bores 35, the diameter of which ball is somewhat smaller than the width of the elongated hole bore 35, so that the ball projects through the corresponding elongated hole bore 35 in certain regions and is guided to be movable, radially and rotationally, between the ridges 36. In place of the delimitation sleeve, in this exemplary embodiment the drive piece 6′ is screwed onto the control cylinder 3′ with its inside thread 62 and encloses the ridges 36, and thereby, once again, a ball cage for the two balls 38 is delimited. The drive piece 6′ thereby simultaneously takes on the task of the delimitation sleeve that is present in the first exemplary embodiment.

The control piston 5′ essentially corresponds to the control piston 5 of the first exemplary embodiment, wherein, however, the diameter-reduced end-side ledge provided with an outside thread is not present, since the drive piece 6′ in this second exemplary embodiment is not fastened to the control piston 5′, but rather to the control cylinder 3.

The drive piece 6′ essentially corresponds to the drive piece 6 of the first exemplary embodiment, wherein merely, in addition, a circumferential ring groove 64 for holding a sealing ring is provided on the inside, subsequent to the section 61 that has a reduced inside diameter.

The method of functioning of this operating device essentially corresponds to the operating device according to the first exemplary embodiment. In the operating position of the handle 1′ with its setting sleeve 14′, in which the O-ring 25 of the adapter piece 2, which ring is arranged in the groove 22′ and serves as an engagement element, engage into the upper, first engagement groove 16 of the setting sleeve 14′, the inner gear mechanism of the setting sleeve 14 is in engagement with the outer gear mechanism 63 of the drive piece 6′. In this operating position, transfer of a torque from the handle 1′ to the drive piece 6′ that is connected to the control spindle 81 of the upper valve part 8 is made possible.

The handle 1′ can now once again be displaced on the adapter piece 2′, with its setting sleeve 14′ that is connected to the adapter piece 2′ so as to be longitudinally displaceable, by means of pulling on the handle piece 11 until the O-ring 25′ engages into the second, lower engagement groove 17 of the setting sleeve 14′. In this position, the inner gear mechanism 18 of the setting sleeve 14′ is out of engagement with the outer gear mechanism 63 of the drive piece 6′ (see FIG. 17). By means of rotating the handle piece 11, the adapter piece 2′, which is connected to the setting sleeve 14′ in a torque-proof manner, can now be adjusted axially relative to the control cylinder 3′, by way of the threaded engagement with the outside thread 33 of the cylinder.

When switching the handle 1′, with its setting sleeve 14′, from the operating position to this adjustment position, a tension force is required for bringing the O-ring 25 out of the first, upper engagement groove 16, so as to bring it into the second, lower engagement groove 17. In order to prevent the handle piece 11, with the O-ring 25, from being brought beyond the lower engagement groove 17 by means of the effect of an excessive tension force, and being pulled off from the control piston 5, a retainer is provided between the adapter piece 2′ and the setting sleeve 14′. For this purpose, the setting sleeve 14′ has an inside thread ridge 140 that runs on the inside, into which ridge an outside thread ridge 20 provided on the adapter piece 2′, to run circumferentially on the outside, can be screwed. During the course of installation, the adapter piece 2′ is screwed into the circumferential inside thread ridge 140 of the setting sleeve 14′ with its outside thread ridge 20 and subsequently over-tightened. Afterward, the outside thread ridge 20 is situated behind the inside thread ridge 140, viewed in the direction of the handle part 11. The adapter piece 2′ is thereby held axially in the setting sleeve 14′ so as not to come loose.

Subsequently, the setting sleeve 14 can once again be displaced along the adapter piece 2′, by means of pressure on the handle piece 11, until the O-ring 25 engages into the first, upper engagement groove 16 of the setting sleeve 14. The operating unit is now adjusted relative to the installation sleeve 7. It is in the operating position (see FIG. 19).

By means of pressing on the handle 1′, it can be brought completely into a position in which it is countersunk into the installation sleeve 7, corresponding to the operating unit according to the above first exemplary embodiment, in which position it is held by means of the balls located in the holding region 522 of the control motion link 52 of the control cylinder.

1. An upper valve part having a head piece (83) through which a control spindle (81) passes axially, by way of which spindle a valve body arranged in the head piece (83) can be activated, and which spindle is connected to an operating part that comprises a handle (1), wherein the handle (1) can be displaceably fixed in place in at least two axial positions, relative to the head piece, coaxially to the control spindle (81), by way of a locking device that is provided, and wherein the locking device comprises at least one control motion link (52) that has at least two locking positions, into which an engagement part engages, which part is arranged on a control component that is arranged, relative to the control motion link (52), so as to be coaxially displaceable relative to the control spindle (81), and is connected to the handle (1), wherein the engagement part is formed by a ball (38) that is introduced into an elongated hole bore (35) that is arranged in the component, in such a manner that the ball (38) engages into the control cam (52) with a spherical section, wherein a ball cage is provided to surround the elongated hole bore, wherein the ball (38) is guided in the ball cage to move circumferentially and radially.

2. The upper valve part according to claim 1, wherein an annular spring (9) is arranged in the ball cage, by way of which spring the at least one ball (38) is biased against the control cam.

3. The upper valve part according to claim 1, wherein the ball cage is configured to be ring-shaped and has an inner circumferential groove in which the ball (38) is guided.

4. The upper valve part according to claim 1, wherein the control component is formed by a control cylinder (3) in which a control piston (5) is displaceably arranged, wherein the piston has the control cam (52).

5. The upper valve part according to claim 4, wherein a spring (59) is arranged between the control cylinder (3) and the control piston (5), wherein the spring is biased against the control cylinder (3).

6. The upper valve part according to claim 4, wherein a holder (54) for connecting to a connection section of the control spindle (81) is provided on the control piston (5), wherein the control piston (5) is connected by way of the holder (54) to the control spindle (81).

7. The upper valve part according to claim 4, wherein the handle (1) has a setting sleeve (14) that surrounds the control piston (5), at least in certain regions.

8. The upper valve part according to claim 7, wherein the setting sleeve (14) has an inner gear mechanism (18) that engages into an outer gear mechanism (63) provided on the control piston (5), and thereby the handle (1) is guided so that it the handle (1) can be displaced axially along the control piston (5).

9. The upper valve part according to claim 4, wherein the control cylinder (3) has an outside thread (33) onto which an adapter piece (2) is screwed with an inside thread (24) of the adapter piece (2), wherein the adapter piece (2) is held in the setting sleeve (14) of the handle (1) in a torque-proof manner as well as in a longitudinally displaceable manner.

10. The upper valve part according to claim 9, wherein the adapter piece (2) has engagement projections (23), wherein on the inside, in the setting sleeve (14), at least one engagement groove (16, 17) is provided, into which the engagement projections (23) can be engaged in a defined position of the adapter piece (2) in the setting sleeve (14).

11. The upper valve part according to claim 10, wherein on the inside, at least two engagement grooves (16, 17) are provided in the setting sleeve axially spaced apart from one another and preferably running radially.

12. The upper valve part according to claim 1, wherein an installation sleeve (7) is provided, the inside diameter of which essentially corresponds to the outside diameter of the handle (1), wherein the position of the handle (1) can be set at a defined distance from the installation sleeve (7).

13. The upper valve part according to claim 12, wherein the installation sleeve (7) has a circumferential collar (71) that forms a common plane with the surface of the handle (1) when the handle (1) is positioned in a defined position in the installation sleeve (7).

14. A sanitary fitting having an the upper valve part according to claim 1.
